(19) United States
(12) Patent Application Publication
(10) Pub. No.: US 2026/0048716 A1
(43) Pub. Date: Feb. 19, 2026

(54) SYSTEM

(71) Applicant: SOFTBANK GROUP CORP., Tokyo (JP)

(72) Inventor: Hiroshi YOSHIDA, Tokyo (JP)

(73) Assignee: SOFTBANK GROUP CORP., Tokyo (JP)

(21) Appl. No.: 19/299,453

(22) Filed: Aug. 14, 2025

(30) Foreign Application Priority Data
Aug. 16, 2024 (JP) 2024-137164

(51) Int. Cl. B60R 25/10; B60R 25/30; G06F 40/35; G06V 20/59; G06V 40/10

(52) U.S. Cl. CPC B60R 25/1004; B60R 25/302; G06F 40/35; G06V 20/59; G06V 40/10

(57) ABSTRACT

A system includes a processor that receives data from a camera equipped with a human detection sensor, detects the presence of a person inside a vehicle based on the data, emits a voice alert when a vehicle key is removed and a person is detected as remaining inside the vehicle, transmits alert information to an external communication device, and sends a notification to a plurality of registered terminals based on the transmitted alert information.

### CROSS-REFERENCE TO RELATED APPLICATION

This application is based on and claims priority under 35 USC 119 from Japanese Patent Application No. 2024-137164 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

There have been numerous incidents wherein children are accidentally left behind inside vehicles, leading to severe health risks or fatal accidents, especially in cases of high interior temperatures or lack of timely detection. Existing safety measures are insufficient in reliably detecting the presence of children in the vehicle, issuing timely warnings, and providing effective guidance for rescue efforts. Therefore, there is a need for a more robust and comprehensive system that can rapidly detect such dangerous situations, promptly notify responsible individuals, and support rescue actions.

### SUMMARY

In order to address these problems, the present invention provides a system including a processor that receives data from a human detection sensor-equipped camera to identify persons left inside a vehicle, emits audio alerts when the vehicle key is removed and a person is detected, and transmits alert information to external communication devices along with notifications to registered terminals. Additionally, the processor receives temperature data from a portable device, detects abnormal temperature conditions, emits corresponding audio alerts, and communicates such alerts externally. The invention further incorporates natural language processing technology to interact with detected individuals, collect situational information, provide rescue instructions, and transmit this information to external devices for enhanced emergency response.

“Processor” means an electronic device or circuit capable of executing programmed instructions and performing operations necessary for processing data and controlling system functions.

“Camera equipped with a human detection sensor” means a camera device integrated with a sensor capable of detecting the presence of a person within its sensing area.

“Vehicle” means a means of transportation, such as an automobile, intended for transporting people.

“Voice alert” means an audible warning or message output by a speaker or similar device to notify users of a specific condition or event.

“Alert information” means data or a message generated by the system to indicate the detection of a hazardous or abnormal condition.

“External communication device” means a device or interface used for transmitting or receiving data to and from entities outside the system, such as smartphones or remote servers.

“Registered terminals” means electronic devices, such as smartphones or tablets, which have been previously enrolled or associated with the system to receive notifications and alerts.

“Temperature data” means information obtained from a temperature sensor representing the measured temperature inside the vehicle.

“Portable device” means a movable electronic device equipped with a sensor, such as a temperature sensor, capable of monitoring environmental conditions within the vehicle.

“Natural language processing technology” means computational methods and algorithms designed to interpret, understand, and generate human language, enabling conversational interactions between the system and users.

“Dialogue” means an interactive exchange of messages or questions and responses carried out between the system and a user to determine situational context or provide guidance.

“Situation information” means details or data regarding the circumstances or status collected during the interaction between the system and the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

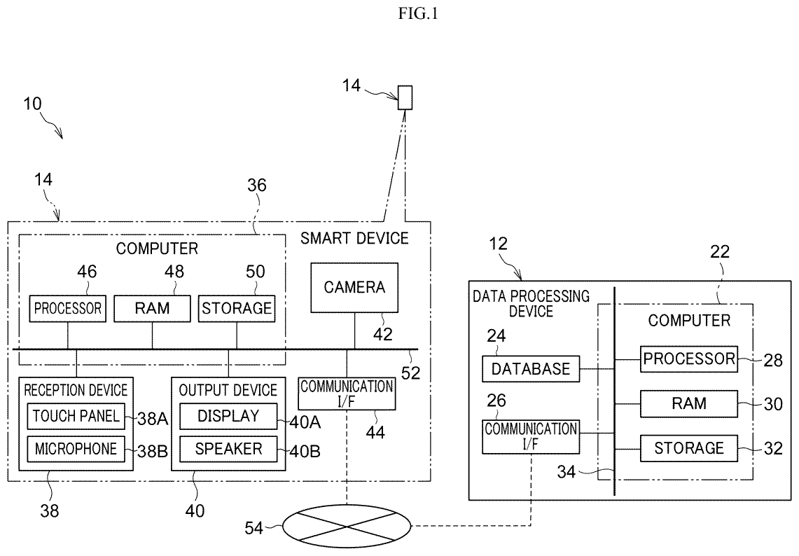

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

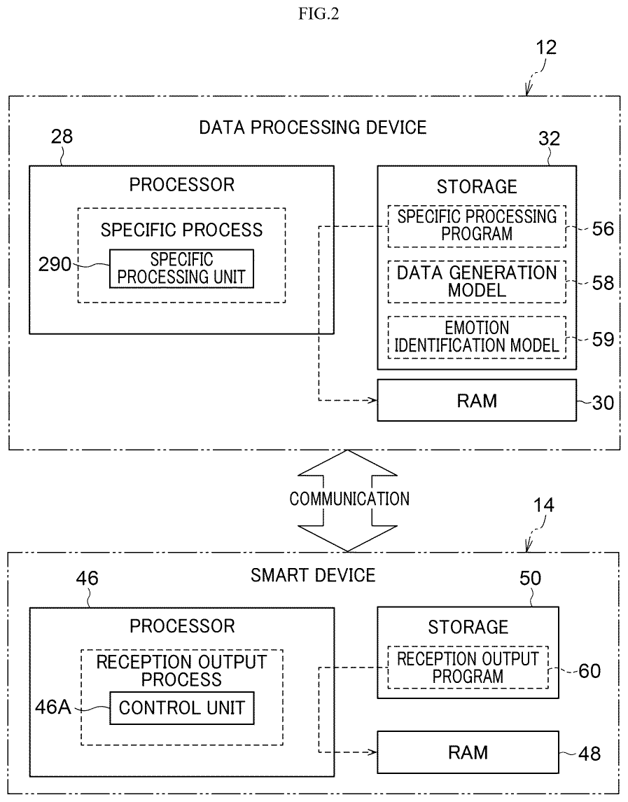

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Abandonment incidents involving children or elderly individuals inside vehicles pose significant risks, especially under extreme environmental conditions such as high temperatures. Existing alert systems merely issue simple warnings based on presence detection or temperature anomalies and do not provide context-sensitive guidance, interactive support, or sufficient information relay to caregivers and emergency contacts. As a result, delays in detection, lack of individualized intervention, and insufficient real-time information sharing may lead to serious accidents and inability to secure prompt and effective rescue.

The specific processing by the specific processing unit 290 of the data processing device 12 in Example 1 is realized by the following means.

The present invention provides a server including a processor configured to periodically analyze person detection and temperature data from in-vehicle sensors, detect remaining occupants and hazardous conditions, issue audio and network warnings, notify registered mobile communication terminals of detected dangers, activate a generative language processing model based on predetermined instruction sentences to conduct interactive dialogue with the person left in the vehicle, and relay real-time conversational data and responses to caregivers and external terminals. This enables immediate, context-sensitive guidance, ensures efficient information delivery to responsible parties, and supports timely and appropriate rescue actions to prevent serious injury or fatality.

The term “processor” refers to a hardware or software element capable of executing instructions to process data and control operations as described in the system.

The term “detection device” refers to an apparatus equipped with one or more sensors, such as motion sensors or cameras, configured to detect the presence of individuals inside a vehicle.

The term “person detection data” refers to information generated or extracted by a detection device that indicates whether an individual is present within a monitored space, such as the interior of a vehicle.

The term “operational state signals” refers to electronic or logical indicators representing the status of a vehicle's systems, including but not limited to engine operation and locking or unlocking events.

The term “audio warning” refers to a sound-based alert, such as a synthesized voice or alarm, transmitted via an on-board audio output to notify individuals of a detected hazard or condition.

The term “alert data” refers to digital information representing the occurrence of a detected abnormal situation or hazard, suitable for communication to external devices.

The term “communication network” refers to a system enabling electronic data transmission between devices, including wired and wireless networks such as mobile, local area, or wide-area networks.

The term “information processing device” refers to any device capable of receiving, storing, and processing electronic data, including a server or cloud-based system.

The term “mobile communication terminals” refers to portable electronic devices capable of receiving messages or notifications over a communication network, such as smartphones or tablet computers.

The term “conversation generation processing device” refers to a computational resource, such as a generative artificial intelligence model, designed to process input prompts and generate interactive conversation content in natural language.

The term “instruction sentence” refers to a predefined or dynamically generated text input that contains situational descriptions or guidance, used as a prompt for the conversation generation processing device.

The term “response data” refers to information representing verbal or nonverbal replies from an individual in response to prompts or instructions provided by the system.

The term “temperature detection device” refers to a sensor or apparatus configured to measure and report the ambient temperature within the vehicle.

The term “abnormal temperature” refers to a measured temperature value that exceeds a preset safety threshold for the interior of the vehicle.

The term “generative information processing model” refers to a computational system employing artificial intelligence, especially large language models, capable of generating contextually appropriate and coherent textual content based on input prompts.

The term “external terminals” refers to computing devices located outside the vehicle, such as servers, computers, or mobile communication terminals, which are configured to receive data or notifications from the system.

### Embodiment for Implementing the Invention

The present invention can be implemented by utilizing a combination of detection devices, temperature sensors, audio output units, network-enabled terminals, a processor-equipped server, and a generative AI model capable of natural language processing. Below, the details, manufacturing, use, configuration, and operation procedures for the invention based on the appended claims are described.

The terminal is installed inside a vehicle and comprises a detection device, such as a camera combined with a motion sensor, and a temperature detection device, such as a digital thermistor or semiconductor-based temperature sensor. The terminal is connected to an audio output unit (such as a speaker) and a network communication module (such as a 4G/LTE modem or Wi-Fi module).

The terminal periodically acquires person detection data. For example, a motion sensor, such as a passive infrared sensor (PIR), in combination with a compact camera, detects movement and captures images inside the cabin. The terminal analyzes raw data using installed software, for instance, OpenCV for image processing and detection algorithms implemented in Python.

The terminal further monitors the operational state signals of the vehicle, specifically the engine and lock status. The terminal may access CAN bus data to determine the operational state or use dedicated sensors for ignition and key condition monitoring.

If a subject is detected after the engine is turned off and the key is removed, the terminal outputs an audio warning through the speaker using synthesized speech generated by voice synthesis software, such as eSpeak NG or Google Text-to-Speech API.

Upon issuing a warning, the terminal generates and transmits alert data, including detection results and relevant timestamps, to a remote server via a communication network using an HTTPS or MQTT protocol.

The server, which may be implemented as an information processing device on a virtual machine or dedicated hardware platform (for example, a cloud service platform), receives alert data, parses the received information using web server software (such as Node.js or Python Flask), and identifies the registered mobile communication terminals (e.g., smartphones or tablet computers) associated with the vehicle.

The server sends a warning notification to each registered mobile communication terminal using commercial push notification services, such as Firebase Cloud Messaging or Apple Push Notification Service.

Temperature monitoring is performed by the terminal using its onboard temperature sensor (for instance, DHT22 or a similar digital temperature sensor). When the measured temperature exceeds a preset safety threshold, the terminal outputs an additional audio warning and transmits abnormal temperature data to the server. The server then notifies all registered mobile communication terminals of the dangerous temperature.

Upon receiving alert information, the server activates a generative AI model (generative information processing model) capable of natural language generation, such as a cloud-based large language model or an equivalent in-house solution. The server constructs a prompt sentence that describes the detected scenario, for example, as follows.

“A child has been detected left inside a vehicle after the engine was switched off. Please initiate a safety check and gently guide the child to press the door unlock button if possible. Confirm their well-being and keep talking.”

This prompt sentence is sent as an instruction to the generative AI model, which responds by generating conversational content appropriate for the situation and suitable for communication with a child.

The server delivers the AI-generated conversation to the terminal. The terminal outputs the conversation as audio through the onboard speaker. If the user (in this embodiment, the child or occupant) responds verbally, the terminal uses a microphone and speech-to-text software, such as a cloud speech recognition API, to transcribe the response. The terminal transmits the response data to the server.

The server records the conversation and continuously updates all registered external terminals (such as smartphones) with the ongoing dialogue and status information. This real-time communication ensures that caregivers and responsible parties are kept aware of the current situation and can take immediate action if necessary.

The entire system may be implemented and managed using standard computing hardware and widely available commercial or open-source software frameworks. The described invention is not limited to a specific hardware implementation and may be realized using any components or software that fulfill the functions set forth in the claims. The described configuration enables efficient, practical, and robust execution for rapid detection, communication, and rescue operations in situations of accidental abandonment in vehicles.

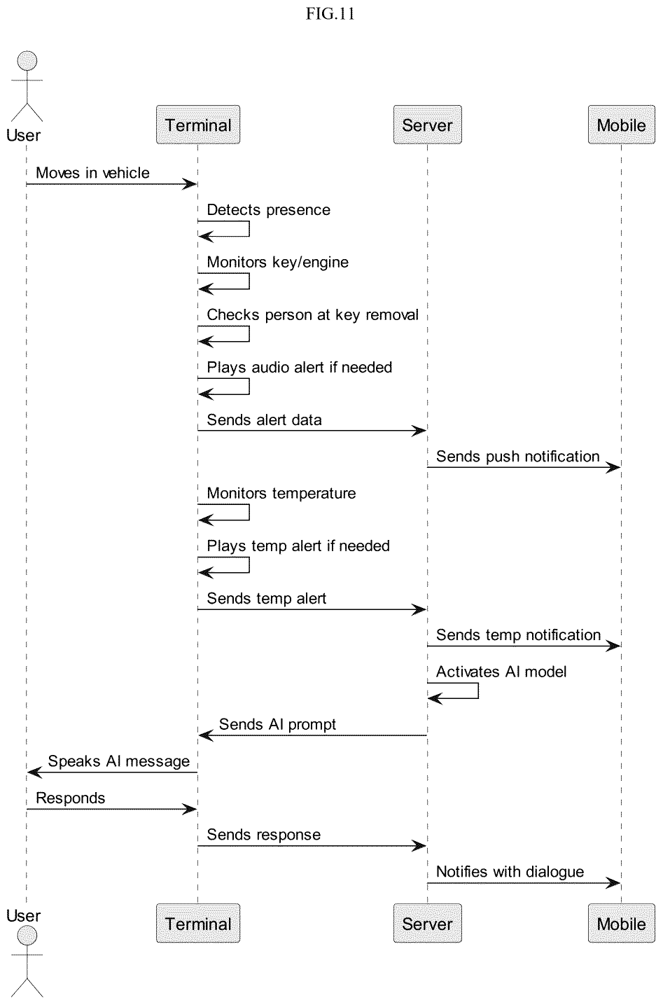

The following describes the processing flow using FIG. 11.

### Step 1:

The terminal collects sensor data inside the vehicle. As input, the terminal acquires data from the motion sensor and camera, such as infrared signals and captured images, every 10 seconds. The terminal processes the sensor data by applying movement detection algorithms and image recognition (using, for example, OpenCV), and determines whether any person is present in the cabin. The output is a presence flag and detection results, which are saved to local storage.

### Step 2:

The terminal monitors the operational state of the vehicle. As input, the terminal receives signals from the ignition switch, CAN bus, or dedicated key-status sensors to determine engine-off and key removal events. The data are processed by evaluating whether the engine is stopped and the key has been pulled out. The output is a state flag indicating the vehicle is vacant, stored and updated in memory.

### Step 3:

The terminal judges if a person remains in the vehicle at the moment the key is removed. As input, the terminal compares the latest presence flag with the current operational state flag. The terminal performs a logical check: if the presence flag is true and the vehicle is vacated, the terminal triggers an event. The output is an alert trigger signal.

### Step 4:

The terminal issues an audio warning if necessary. As input, the terminal takes the alert trigger signal. The terminal synthesizes an audio message using voice synthesis software, and outputs the message as sound through the speaker inside the vehicle. The output is the audio alert.

### Step 5:

The terminal transmits alert data to the server. As input, the terminal gathers the current detection results and vehicle status. The terminal formats these data into a structured alert message (e.g., JSON) and sends it via HTTPS or MQTT protocol over the mobile network. The output is the successful transmission of alert data to the server.

### Step 6:

The server receives the alert data. As input, the server accepts the alert message from the terminal. The server processes the data by parsing the incoming message, extracting relevant fields such as vehicle ID, detection flag, and timestamp. The output is a decoded, actionable event record within the server's database.

### Step 7:

The server notifies registered mobile terminals of the alert. As input, the server uses the decoded alert data and queries its user registration database for associated mobile device tokens. The server composes a notification message and sends it using push notification services (e.g., Firebase Cloud Messaging). The output is a push alert delivered to each authorized user's device.

### Step 8:

The terminal monitors the vehicle cabin temperature. As input, the terminal continuously reads ambient temperature data from onboard sensors at set intervals (e.g., every minute). The terminal processes this data by comparing the measured temperature to a pre-set safety threshold. The output is either a normal state update or, if the threshold is exceeded, an abnormal temperature flag.

### Step 9:

The terminal issues an audio warning for abnormal temperature. As input, the terminal receives the abnormal temperature flag. The terminal uses voice synthesis software to generate a warning phrase and outputs the message via the speaker. The output is the emission of the temperature alert sound.

### Step 10:

The terminal transmits abnormal temperature data to the server. As input, the terminal gathers the temperature reading, timestamp, and other context information. The terminal formats this into a message and sends it over the network to the server. The output is successful delivery of the abnormal temperature alert to the server.

### Step 11:

The server notifies users of the abnormal temperature. As input, the server processes the incoming abnormal temperature data and identifies associated mobile terminals. The server generates a notification message and sends it to each registered device via the push notification service. The output is the delivery of emergency alerts regarding high temperature to users' mobile terminals.

### Step 12:

The server activates the generative AI model upon receiving alert information. As input, the server composes a prompt sentence that explains the situation, such as: “A child has been detected left inside a vehicle after the engine was switched off. Please initiate a safety check and gently guide the child to press the door unlock button if possible. Confirm their well-being and keep talking.” The server submits this prompt to the generative AI model. The data are processed by the AI model to produce a suitable conversational phrase. The output is an AI-generated message.

### Step 13:

The server delivers the AI-generated conversational message to the terminal and collects responses. As input, the server receives the AI-generated conversation output. The server transmits the message to the terminal, where it is played as audio to the user. If the user responds, the terminal records the audio, performs speech-to-text processing, and sends the transcription back to the server. The output is a conversation log containing prompts and user responses.

### Step 14:

The server logs the ongoing conversation and disseminates the results to external devices. As input, the server gathers the conversation records and status updates. The server stores this information in a database, formats progress updates, and sends them via notifications to the registered mobile devices. The output is real-time status delivery to caregivers and authorized parties.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In various environments such as vehicles and industrial facilities, ensuring the safety of individuals can be difficult, especially when it is necessary to detect the presence of a person in dangerous situations such as remaining in locked vehicles or in areas with abnormal temperatures. Conventional alert systems often lack the ability to provide personalized situational guidance or real-time interaction with the users, leading to insufficient or delayed responses in emergency situations. Furthermore, conventional systems do not adequately utilize recent advances in generative artificial intelligence models for context-aware dialog or adaptive notification generation. There remains a need for an improved safety system capable of intelligent situation monitoring, user-specific guidance, and proactive interventions based on real-time data, dialogue, and emotional state estimation.

The specific processing by the specific processing unit 290 of the data processing device 12 in Application Example 1 is realized by the following means.

The present invention provides a server including a processor configured to receive information from a sensing imaging apparatus, determine the presence of a subject within a mobile body, detect an unlocking operation, transmit warning or temperature abnormality information to external information terminals, generate and output personalized guidance text by using a generative artificial intelligence model based on the warning information and user responses, and store the interaction data in a database. This enables real-time monitoring, adaptive dialog, and personalized alerting, thereby improving the safety of individuals by providing context-aware, immediate, and suitable instructions in various emergency situations.

The term “processor” refers to an electronic data processing unit or circuit, such as a central processing unit (CPU) or microcontroller, configured to execute instructions and manage the operation of the system.

The term “imaging apparatus” refers to a device equipped with a sensor for capturing visual or infrared data, such as a camera module with or without motion detection capability.

The term “sensor” refers to a hardware component capable of detecting and measuring physical properties or environmental conditions, such as human presence, temperature, or motion.

The term “mobile body” refers to any movable enclosure or vehicle, including but not limited to automobiles, buses, trains, or similar transportation or conveyance spaces. The term “subject” refers to any target entity within the mobile body whose presence is being monitored, including but not limited to a person, child, or worker.

The term “unlocking operation” refers to an event or action indicating the removal of a key or the disengagement of a locking mechanism within the mobile body.

The term “warning information” refers to data or signals generated in response to detecting a hazardous or abnormal condition, such as the presence of a person inside a locked mobile body or an abnormal temperature.

The term “external information processing apparatus” refers to any external computing system, server, or terminal that receives and processes warning information or related data from the processor.

The term “information terminal” refers to an electronic device, such as a smartphone, tablet, wearable device, or other user interface device, used to receive notifications or instructions from the system.

The term “user response” refers to any feedback, input, or reply provided by a user through the information terminal in reaction to alerts or dialog initiated by the system.

The term “generative model” refers to a machine learning or artificial intelligence model capable of producing natural language text or prompts automatically based on input data or context.

The term “guidance text” refers to any informational or instructional message generated by the generative model to provide context-appropriate direction or advice to the user.

The term “database” refers to an organized collection of structured information or records, such as interaction logs, user responses, and generated guidance texts, managed electronically by the processor.

An embodiment for carrying out the present invention will now be described. The invention may be implemented as a safety management system composed of a processor, an imaging apparatus with a sensor (such as a camera module with a human presence sensor), a temperature measurement unit (such as a temperature sensor), external information processing apparatuses, and a plurality of information terminals. The processor is typically embodied in a computing server configured with data processing functions, communication interfaces, and equipped with memory for storing a database. The server may be implemented as a generic or dedicated computing unit, for example, a virtual or physical machine running a Linux operating system. The imaging apparatus may be configured using a generic microcontroller (for example, a single board computer) connected to a motion sensor and a camera module. The temperature measurement unit may be a digital or analog temperature sensor, such as a commercially available digital sensor. Information terminals may include, without limitation, smartphones, tablets, and wearable devices such as smart glasses, all capable of establishing communications with the server through wireless or wired networks.

The server incorporates software routines for receiving and processing information from the imaging apparatus and temperature measurement unit. The server runs programs that analyze human presence information and temperature data to determine the existence of a subject in a mobile body and the occurrence of abnormal temperatures, respectively. When a hazardous event such as abnormal temperature detection or a subject remaining in the mobile body is recognized, the server triggers a warning via audio sound output through the imaging apparatus, the temperature measurement unit, or the information terminals. The server then transmits warning information, including the nature and location of the event, to external information processing apparatuses and registered information terminals. Examples of software and platforms used to implement the server's programs include a data acquisition module (for collecting sensor data), a database management program (such as SQLite or a cloud database service), a notification service (for transmitting messages to information terminals), text-to-speech software, as well as interfaces to generative AI models such as a machine learning large language model.

Upon receiving a warning, the server employs a generative AI model to create a prompt sentence tailored to the detected condition and user response. The generative model can be implemented by a machine learning platform capable of natural language generation, such as a commercially available large language model. The resulting prompt sentence is delivered to the intended information terminal to provide situation-specific instructions or guidance to the user. As the user interacts with the prompt, their responses may be collected by the information terminal and transmitted back to the server, where the responses are used for further dialog generation and are also stored in the database for record-keeping and analysis.

Concrete examples include the following. In the case of a mobile body such as a vehicle, if the imaging apparatus detects the presence of a person when the unlocking operation (such as key removal) has occurred, and/or if the temperature measurement unit detects an abnormal temperature inside the vehicle, the server issues a warning message such as “Warning: A person has been detected in the vehicle with high temperature. Please evacuate immediately.” The server then generates a prompt sentence using the generative AI model, such as:
“Are you safe? Can you follow the evacuation procedures?”
or
“The current temperature is very high. How are you feeling? Are you able to leave the area safely?”

These prompt sentences are displayed to the user via the information terminal, such as a smartphone or smart glasses. The user may reply, for example, “I feel dizzy and cannot move quickly.” The server receives the reply, assesses the urgency, generates an additional prompt such as “Please remain calm. Help is on the way. If you can, move to a safe area,” and updates the notification to other registered information terminals as necessary.

In addition to vehicles, this system can be applied in various mobile bodies and environments, such as public transport, industrial facilities, and similar enclosures where real-time monitoring and intelligent guidance in emergency situations is essential. This configuration enables context-aware, adaptive dialog through prompt sentences, and ensures effective safety management using modern sensing technologies, data processing, and generative artificial intelligence.

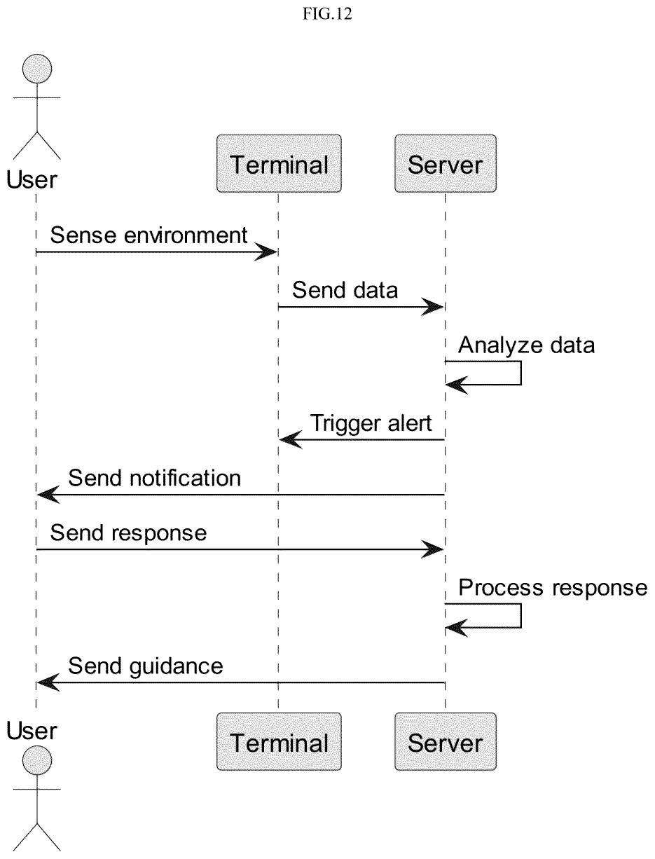

The following describes the processing flow using FIG. 12.

### Step 1:

The terminal collects sensor data and prepares data packets.

Input: Real-time environmental sensor data, including images from an imaging apparatus and values from a temperature measurement unit.

The terminal processes the raw image to detect human presence using image recognition algorithms, analyzes temperature readings, and packages the results into a standardized data format (such as JSON), including time and device ID.

Output: Structured data packet indicating human presence status and temperature level.

### Step 2:

The terminal transmits the data packets to the server.

Input: Structured data packet from Step 1 containing sensor readings and status information.

The terminal establishes a secure communication channel (such as HTTP or MQTT) and sends the data packet to the pre-configured server address.

Output: Sensor data received by the server.

### Step 3:

The server receives and stores incoming sensor data in a database.

Input: Sensor data packets transmitted from one or more terminals.

The server parses the incoming data packet, validates the data integrity, and records relevant fields (device ID, timestamp, human presence, temperature) in a database management system.

Output: Sensor data securely stored and available for real-time or later analysis.

### Step 4:

The server analyzes the received data and detects abnormal conditions.

Input: Sensor data for human presence and temperature from the database.

The server applies threshold logic to determine if a person is present under abnormal or hazardous temperature conditions. This involves comparing temperature values to preset safety limits and checking the status of human presence flags.

Output: Alert condition detected and flagged for further action if any threshold is exceeded.

### Step 5:

The server generates and issues initial alerts.

Input: Alert condition flagged in Step 4.

The server triggers an alert process, which may include generating an audio warning to be broadcast via a terminal, and preparing a warning message containing event type, location, and urgency.

Output: Alerts issued through local audio and warning messages generated for transmission.

### Step 6:

The server transmits alert and warning information to external devices and registered information terminals.

Input: Generated warning messages and alert information.

The server sends notifications and warning messages via push notification services or direct network communication to a list of registered information terminals, such as smartphones and wearable devices.

Output: Warning messages and notifications delivered to all designated information terminals.

### Step 7:

The server constructs a situation-specific prompt sentence using a generative AI model.

Input: Contextual data including alert information, user or environmental status, and prior user responses if available.

The server sends the context as a prompt to a generative AI model, receives the natural-language prompt sentence in return, and logs this sentence for record-keeping. Output:

Generated prompt sentence tailored to the situation.

### Step 8:

The server initiates an interactive dialog with the user via the information terminal.

Input: Generated prompt sentence and the user's current contact information or device identifier.

The server transmits the prompt sentence to the designated information terminal and awaits a user response.

Output: Prompt sentence displayed or spoken to the user, and user's response collected for further processing.

### Step 9:

The server analyzes the user's response and generates adaptive instructions.

Input: User's response received from the information terminal.

The server processes this natural language response, optionally using natural language understanding algorithms and sentiment analysis, then determines the user's condition (such as urgency or distress). The server, using the generative AI model, creates further instructions or reassurance as appropriate.

Output: Adaptive instruction or follow-up prompt sentence tailored to the user's state.

### Step 10:

The server logs all dialog, alerts, and user responses, and notifies supervisors as necessary.

Input: All dialog history, including prompt sentences, user responses, alert events, and adaptive instructions.

The server stores the complete interaction in the database for audit and analytics, and, if necessary, generates special notifications for supervisors or emergency contacts, providing them with the user's current status and dialog history.

Output: Comprehensive record of the event, real-time escalation to responsible parties if required.

### Step 11:

The user receives alerts and prompt sentences and takes action.

Input: Notifications, alert messages, and guidance or instructions displayed or played back on the information terminal.

The user interprets the information and performs appropriate safety actions, such as evacuating an area, following suggested procedures, or providing feedback through the terminal.

Output: User's compliance with guidance, and new user input available for ongoing dialog.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

The problem to be solved by the present invention is to prevent incidents in which individuals, particularly children, are left unattended inside a vehicle, which can lead to potentially fatal situations due to prolonged entrapment or exposure to abnormal temperatures. Additionally, there is a need for a system that can rapidly detect such circumstances, automatically notify remote guardians or responsible parties, and provide interactive support and instructions to the person left inside, even in cases where verbal or emotional guidance may be necessary for safety and reassurance.

The specific processing by the specific processing unit 290 of the data processing device 12 in Example 2 is realized by the following means.

The present invention provides a server including a processor configured to receive information from a sensing device having human detection capabilities, monitor environmental parameters within a mobile body, determine abnormal conditions based on predefined criteria, output audio alerts when necessary, transmit alert data to external devices, send notifications to multiple registered information terminals, and perform situation verification and behavioral guidance through natural language interaction using a generative information processing model. This enables prompt detection of a person's presence or abnormal conditions inside a vehicle, rapid and reliable remote alerts to guardians, and provision of real-time, adaptive dialogue and instructions to individuals remaining in the vehicle, greatly reducing the risk of unattended entrapment.

The term “imaging device having a human detection function” refers to a sensing apparatus equipped with both visual or infrared image capture capability and a sensor or algorithm for detecting the presence or absence of a person within a defined space.

The term “mobile body” refers to any movable structure or vehicle, such as an automobile, bus, or similar transportation means, in which living beings or cargo may reside.

The term “operation medium” refers to a physical element, such as a key or key-like device, which enables or disables the power source or operational state of the mobile body.

The term “audio alert information” refers to a message or signal output in the form of sound or voice designed to provide a warning or notification to individuals inside the mobile body.

The term “external information processing device” refers to a data processing unit or computing system located outside the mobile body, capable of receiving communications, storing records, and executing processing tasks.

The term “information terminal device” refers to an electronic device, such as a mobile phone, tablet, or computer, owned or operated by an end user, which can receive and display notifications or messages.

The term “environmental data” refers to measurements of physical parameters within the mobile body, such as temperature, humidity, or air quality, obtained by a suitable sensor.

The term “portable observation device” refers to a mobile and easily installable sensor unit designed to monitor environmental parameters inside the mobile body.

The term “generative information processing model” refers to a machine learning or artificial intelligence-based computational system capable of producing context-aware output, such as natural language dialogue, in response to input information.

The term “natural language dialogue” refers to an interactive sequence of communications between a machine and a human participant using ordinary spoken or written language.

The term “alert information” refers to data indicating the detection of an abnormal or emergency situation within the mobile body, intended for prompt dissemination and response.

The term “situation information” refers to descriptive data regarding the conditions, events, or context currently occurring inside the mobile body, collected for the purposes of assessment or response.

The term “response information” refers to actions taken, answers provided, or feedback generated by end users or terminal devices following receipt of a notification or alert.

The term “behavioral instruction” refers to actionable advice or guidance, generated by the system or operator, intended to direct the actions of an individual inside the mobile body during an emergency or abnormal event.

One embodiment for implementing the present invention will be described below.

A system according to the present invention may include various processors, terminals, and server devices. The main configuration comprises an imaging device with a human detection function (such as a smart camera equipped with a human presence sensor), one or more portable observation devices for monitoring environmental data (for example, a temperature sensor module), multiple information terminal devices (such as smartphones or tablet computers), and a server configured to manage processing, communication, data storage, and generative AI dialogue.

The terminal serves as an imaging device equipped with a human detection function. Typically, this may be realized by a single-board computer with a motion or presence sensor, such as a passive infrared (PIR) sensor, and a camera. Specific hardware examples include devices similar to a single-board computer with Linux OS, to which a camera module and PIR sensor can be attached. The terminal also includes a speaker for audio alerts. The terminal is configured with firmware and embedded software to read sensor data, capture images, detect the presence or absence of a person, and communicate information to the server via wired or wireless connections (such as Wi-Fi or cellular communication).

The terminal may further comprise a portable observation device configured to measure environmental parameters inside a mobile body, such as temperature, humidity, or air quality. This observation device may utilize a microcontroller (such as a development board) equipped with temperature sensors. The device is configured with firmware to periodically monitor the environmental state and transmit the measured data to the server. The threshold for abnormal states can be set via a user interface on the information terminal device, and transmitted to the portable observation device for reference.

The server may be realized as a cloud-based or on-premise computational resource having a processor, non-transitory memory, and network connectivity. The server receives information from the terminal and portable observation device, stores the information, and determines whether abnormal or emergency situations exist based on criteria such as the presence of a person after an ignition stop or removal of an operation medium, or when environmental parameters such as temperature exceed preset thresholds.

When the server detects such abnormal situations, the server outputs audio alert information, for example using a text-to-speech engine, relayed through the speaker of the terminal within the mobile body. At the same time, the server transmits alert information to multiple registered external information terminal devices, such as smartphones or tablets possessed by guardians or administrators, using a push notification service or messaging protocol.

Furthermore, the server may be configured to employ a generative information processing model (such as a generative AI language model API). The server invokes the generative AI model to generate and deliver natural language dialogue aimed at confirming the situation and providing behavioral instructions to a person remaining within the mobile body. The server also implements an emotion analysis algorithm (such as an emotion recognition software library) to analyze detected responses, optimizing dialogue to provide reassurance and safety guidance adapted to the emotional state of the occupant.

The end user, typically a child or other individual present in the mobile body, can respond to the system's audio prompts and receive instructions. Users of external information terminal devices can receive, view, and respond to notifications about the alert situation. In addition, users may access stored situation records and response logs to manage emergency events.

A practical example is as follows: the terminal detects that the power source of a vehicle has been turned off and the operation medium has been removed, yet a person remains seated inside the cabin compartment. The terminal transmits this situation to the server and issues an immediate audio alert. The server simultaneously sends a push notification stating “Emergency: Person left in vehicle after shutdown” to the registered information terminal devices. The server also activates the generative AI dialogue model, beginning a natural language conversation such as “Hello, we detected someone inside the car. Can you hear me?” If the user replies “Help!”, the server analyzes this emotional state, responds with a reassuring instruction (such as “Don't worry, help is on the way. Can you find the lock button?”), and records the entire dialogue. The server shares situation updates, instructions provided, and emotional analysis with all relevant external users.

An example of a prompt sentence for the generative AI model is as follows:
“If a young child is detected alone inside a vehicle after the engine has stopped, how would you initiate a calming conversation, collect situational information, and instruct them to seek help or unlock the doors? Please provide dialogue suitable for a young child, taking their likely emotional state into account.”

In this way, the system coordinates detection, alerting, response, and communication using specific hardware and software, as set forth in the claims, to provide timely and reliable assistance during an emergency situation involving an individual left in a mobile body.

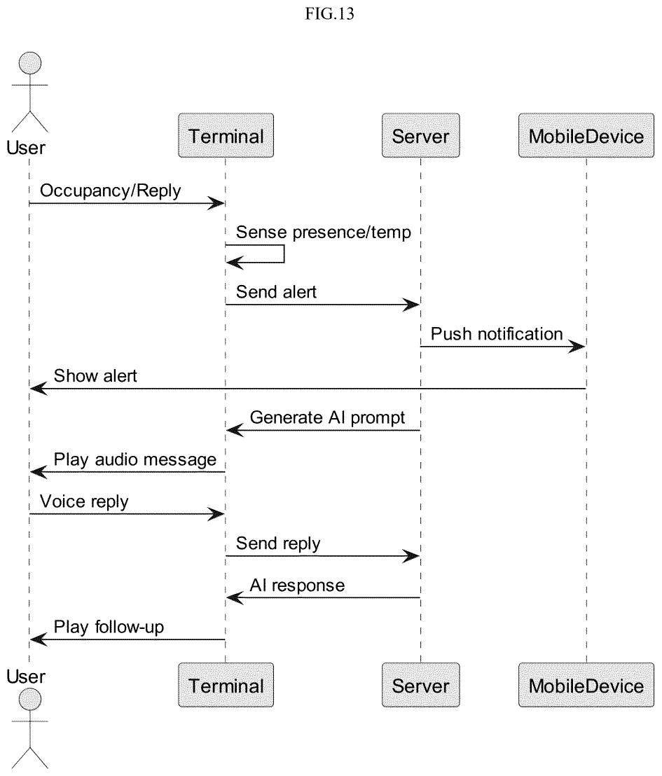

The following describes the processing flow using FIG. 13.

### Step 1:

The terminal periodically acquires data from the human presence sensor and the camera installed inside the mobile body. The input is sensor readings and image data. Based on this input, the terminal performs data processing to detect whether a human is present by using motion detection algorithms and threshold evaluation. The output is a presence status (such as “person detected” or “no person detected”) stored in local memory and prepared for further actions.

### Step 2:

The terminal monitors the operational status of the mobile body, specifically checking whether the power source is turned off and whether the operation medium (such as a key) has been removed. The input is signals or data from the mobile body's system interface. The terminal processes these inputs to determine if both shutdown and medium removal conditions are satisfied. The output is an event status indicating “engine off and key removed” or “normal state”.

### Step 3:

The terminal evaluates whether both “person detected” and “engine off/key removed” conditions are simultaneously satisfied. The input is the output from the previous two steps. Based on this input, the terminal executes a logical decision operation. If both conditions are met, the output is a command to issue an in-vehicle audio alert.

### Step 4:

The terminal activates its speaker and plays an audio alert message, such as “Warning: Someone is still inside!” The input is the alert command from the previous step. The terminal processes this input by retrieving the appropriate message and controlling the audio system. The output is an audible warning broadcasted inside the mobile body.

### Step 5:

The terminal composes an alert packet containing information such as the presence status, the operational event status, time, and device identifier. The input is the data generated in previous steps. The terminal processes this information to format a standardized packet and transmits it to the server via a network connection. The output is the delivery of the alert packet to the server.

### Step 6:

The server receives the alert packet transmitted from the terminal. The input is the received alert packet. The server processes the content to authenticate, parse, and register the event in a database. The output is an internal record of the event and a formatted notification ready for distribution.

### Step 7:

The server identifies registered information terminal devices that should receive the notification. The input is the alert event record. The server processes this by querying user registration information and generates corresponding notification messages, such as “Emergency: Person detected inside vehicle after shutdown.” The output is a set of notification messages linked to targeted devices.

### Step 8:

The server transmits push notifications to all registered information terminal devices through a messaging service. The input is the set of messages and device addresses. The server performs network communication to deliver these messages. The output is the appearance of alerts on users' devices.

### Step 9:

The terminal or a portable observation device measures environmental data, such as temperature, inside the mobile body. The input is sensor data readings obtained periodically. The terminal processes these inputs by comparing the measured values to user-set or default thresholds. If the environmental value exceeds the threshold, the output is an abnormal condition flag and a command to produce an audio alert and send an alert packet to the server.

### Step 10:

The terminal plays an audio alert regarding the abnormal environmental condition and sends an environmental alert packet to the server. The input is the abnormal condition flag generated in the previous step. The terminal processes this by playing a pre-set warning message, such as “Temperature is dangerously high!” and formatting/transmitting the alert packet. The output is the in-vehicle audio warning and delivery of the alert to the server.

### Step 11:

The server, upon receiving environmental alert packets, distributes notifications to all registered information terminal devices, repeating steps 6-8. The input is the environmental alert packet. The server processes and generates alert notifications. The output is the delivery of environmental hazard alerts to users.

### Step 12:

The server activates a generative AI model to start a natural language dialogue with the individual inside the mobile body upon receipt of a relevant alert. The input is the alert event and the corresponding dialogue prompt. The server processes these by sending the prompt to the generative AI model and receiving a generated message. The output is the first natural language message, such as “Hello, can you hear me? Are you okay?”

### Step 13:

The user responds verbally to the server's dialogue prompt via the terminal's audio system. The input is the user's spoken reply. The terminal captures audio data, processes it with a speech recognition module, and transcribes it to text. The output is a digital text version of the user's response sent to the server.

### Step 14:

The server performs emotion analysis on the user's response using an emotion recognition algorithm. The input is the transcribed text from the previous step. The server processes the text to identify emotional states such as fear, anxiety, or calmness. The output is an emotion tag and corresponding dialogue adjustment.

### Step 15:

The server generates and sends a follow-up natural language message based on the content and emotion detected in the user's reply. The input is the emotion tag and prior dialogue state. The server processes this by selecting or generating supportive and instructive dialogue, such as “Don't worry, help is coming. Can you find the button to unlock the door?” The output is a new audio message delivered through the terminal's speaker.

### Step 16:

The server records the entire dialogue and emotional states as situation information. The input is all dialogue content, detected emotions, and time-stamped logs. The server processes and stores them as structured records. The output is a retrievable history of the event and user interaction.

### Step 17:

The server notifies all registered information terminal devices about the ongoing situation update, including new instructions given and emotional state analysis. The input is the compiled situation record. The server processes this by formatting concise summary notifications. The output is updated alerts received by guardians or administrators on their devices.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In recent years, with the proliferation of autonomous vehicles and related mobility systems, accidents have arisen where children or vulnerable persons are unintentionally left inside vehicle compartments, leading to serious risks such as heatstroke, panic, emotional distress, or even death. Existing safety systems may lack comprehensive detection, real-time communication, and proactive guidance for both the person left behind and external guardians. Furthermore, conventional systems are unable to adaptively communicate or instruct the person left in the vehicle based on their emotional state, nor can they update multiple concerned parties about the situation as it evolves. Therefore, there is a need for a system that provides accurate detection, immediate emergency notification, intelligent dialogue, emotion analysis, and real-time status reporting to ensure the safety and psychological comfort of individuals left inside vehicles.

The specific processing by the specific processing unit 290 of the data processing device 12 in Application Example 2 is realized by the following means.

The present invention provides a server including one or more processors configured to receive detection data from an imaging device and measuring device installed in a vehicle compartment, detect the presence of a person, issue audible warnings when certain risk conditions are met, transmit warning information to an external communication device, send notifications to multiple registered terminals, initiate intelligent dialogue with the detected person using a generative artificial intelligence model, analyze the emotional state of the person based on their responses, and generate context-appropriate guidance and instructions, while providing real-time updates to external parties. This enables proactive and adaptive support for individuals left inside vehicles, rapid emergency notification to guardians, emotional monitoring, and coordinated rescue efforts based on evolving circumstances.

The term “imaging device having a human detection function” refers to an apparatus equipped with one or more sensors or cameras and capable of detecting the presence or absence of a person within a designated area, such as a vehicle compartment, using physical sensing, image processing, or a combination thereof.

The term “detection information” refers to data output by detection devices, such as imaging devices or sensors, that indicates the presence, absence, or condition of a person or object within a monitored area.

The term “vehicle compartment” refers to the internal space within a vehicle where occupants or cargo may be present, including but not limited to passenger areas, cabins, or cargo areas.

The term “activation apparatus for the vehicle” refers to a mechanical, electronic, or software-based device or component used to start, stop, or otherwise control the operational state of a vehicle, such as a physical ignition key, an electronic key, or an onboard start/stop system.

The term “audible warning” refers to a sound, message, or alert signal generated and broadcast within an environment to notify individuals audibly of a specific event, risk, or condition.

The term “warning information” refers to electronic data generated in response to a detected risk or abnormal condition, which includes details such as the nature, time, and/or location of the event and is intended for transmission to external systems or parties.

The term “external communication device” refers to any device or system, located outside the monitored environment or vehicle, that facilitates the transmission or reception of information via wired or wireless communication networks.

The term “information processing terminal” refers to an electronic device capable of receiving, processing, and displaying transmitted information, such as a smartphone, tablet, computer, or similar apparatus.

The term “bidirectional communication” refers to a mode of data transmission that allows for the exchange of information in both directions, enabling interactive communication between two or more parties or devices.

The term “generative information processing model” refers to a computing model or software capable of automatically generating content, responses, or instructions tailored to specific situations, typically utilizing artificial intelligence or machine learning algorithms. The term “guidance content including prompt sentences” refers to instructional or supportive messages, questions, or prompts automatically generated and delivered to a person, with the purpose of eliciting a response, guiding behavior, or providing reassurance.

The term “emotion analysis function” refers to a software or processing capability that evaluates and classifies the emotional state or sentiment of a person based on text, speech, physiological signals, or other input data.

The term “instruction sentence” refers to a message or communication generated by a processing system that conveys a specific directive, suggestion, or course of action to a person in a comprehensible manner.

The term “physical quantities” refers to measurable parameters within an environment, such as temperature, humidity, gas concentration, or other relevant environmental conditions.

The term “measurement value” refers to a numeric or symbolic data output obtained from a sensor or measuring apparatus corresponding to a sensed physical quantity.

The term “abnormal condition” refers to a state or parameter value that deviates from predefined normal ranges or thresholds, indicating a possible risk, malfunction, or hazardous situation.

The term “notification information” refers to data generated by a system for the purpose of alerting users or external parties about an event, status update, or warning, often transmitted via communication networks.

The term “dialogue history” refers to a recorded sequence of exchanges or communications between a system and a person over a period of time.

The term “real-time” refers to the capability of processing, transmitting, or acting upon information with minimal delay, such that the actions or outputs are effectively immediate with respect to the occurrence of the original event.

One embodiment for implementing the invention will now be described in detail. The system comprises a terminal installed within a vehicle, multiple external information processing terminals such as mobile devices, and a server configured to perform various data processing and communication functions.

The terminal includes an imaging device equipped with a human detection function, such as a camera module with infrared sensors or motion sensing capabilities. Examples of hardware suitable for this function include embedded computing platforms like Arduino or similar microcontrollers connected to digital cameras and sensor modules. Additionally, the terminal is provided with a temperature or environmental sensor, which may be implemented using platforms such as Raspberry Pi equipped with commercially available temperature sensors.

The terminal is configured to periodically measure physical quantities within the vehicle compartment, such as occupancy status (presence or absence of a person) and temperature readings. The embedded software runs detection routines using these sensor inputs and stores the detection results locally. When the terminal detects that a person remains in the vehicle after removal of the vehicle's activation apparatus (for example, by monitoring the state of an ignition key), or when the temperature exceeds a preconfigured threshold value, the terminal issues an audible warning by activating a speaker or buzzer inside the vehicle. The notification includes the time, sensor values, and relevant status indicators, which the terminal transmits to the server using wireless communication, such as Wi-Fi or cellular connectivity.

The server, deployed on a general-purpose computing platform or hosted in a cloud environment, processes incoming alert information. Suitable server platforms include cloud-based services such as virtual machines from commercial cloud providers, or dedicated physical servers running an operating system capable of executing backend processes (for instance, Linux servers using Python or Node.js).

Upon receiving alert information, the server references its database to identify a list of registered external terminal devices for the relevant vehicle. The server transmits notifications to these devices using standard push notification services, for example, Firebase Cloud Messaging, ensuring that guardians, operators, or responsible parties are immediately informed of an incident.

If a person such as a child or vulnerable occupant is detected in the vehicle, the server initiates a dialogue procedure using a generative artificial intelligence model. An example of such software is a generative AI-based dialogue system built upon commercially available large language models. The server generates context-sensitive prompt sentences intended to reassure and instruct the occupant.

Examples of prompt sentences include:
“Hello, can you hear me? Don't worry, help is on the way. Where are you sitting in the car?”
“It's going to be okay! Can you look for a red button near your seat and try pressing it? You are very brave.”

The generated prompt sentence is communicated to the person in the vehicle through the terminal's speaker system. If the occupant responds verbally or by touching an in-vehicle display panel, the terminal employs speech-to-text processing (for example, using a cloud-based or locally installed speech recognition engine) to convert the response to text and forwards it to the server.

The server analyzes the received text with an emotion analysis function, such as an emotion recognition API provided by a software platform, to determine the current emotional state of the user. If anxiety, panic, or distress is detected, the server adapts its subsequent prompt sentences to provide increased reassurance or more explicit instructions.

After each interaction, the server sends updates, including the dialogue history, latest status, and emotional analysis results, to the registered external information processing terminals, allowing all concerned parties to monitor the situation in real time.

For example, upon receiving a child's response,
“Yes, I'm near the back seat,”
the server processes this statement, determines the emotional condition (e.g., nervous), and generates a further instruction or a comforting message. Such a message might be:
“That's okay, someone is almost there. Is anyone outside the car you can see?”

Notifications reflecting the latest information are pushed to guardians' mobile devices.

The above embodiment may be implemented using widely available hardware and software components, such as general computing processors, commercial cloud services, integrated sensor suites, and third-party artificial intelligence and emotion analysis APIs. This configuration enables flexible deployment, reliable monitoring, adaptive dialogue, emotional support, and proactive guidance to ensure the safety and well-being of vehicle occupants.

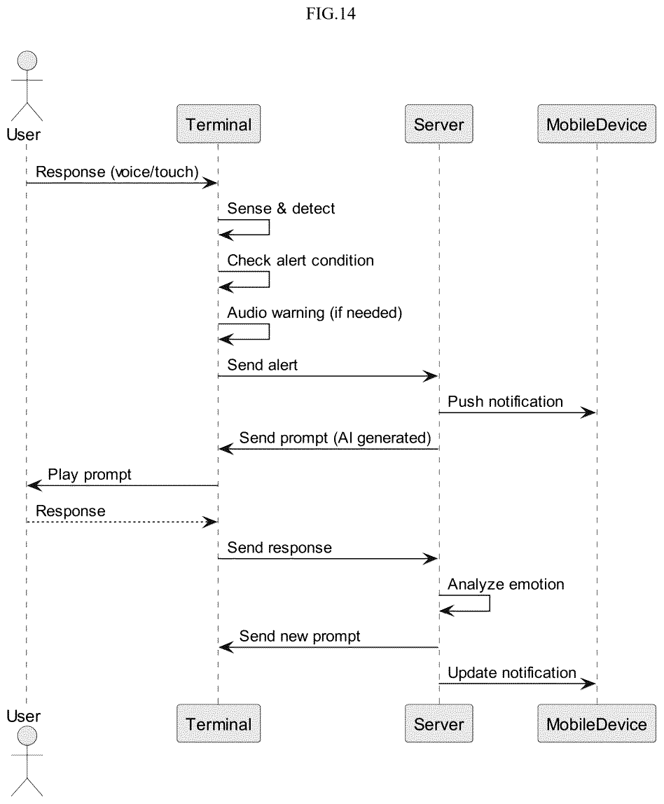

The following describes the processing flow using FIG. 14.

### Step 1:

The terminal collects sensor data within the vehicle. The input includes signals from a human detection imaging device and a physical quantity sensor such as a temperature sensor. The terminal processes these raw signals to determine whether a person is present and to measure the current temperature. The terminal stores the detection results and sensor readings locally and updates its status log.

### Step 2:

The terminal evaluates the processed sensor results. If the terminal detects a person in the vehicle after the activation apparatus is removed, or the temperature exceeds a predetermined threshold, the terminal activates an audible warning device inside the vehicle to issue a warning message. The input for this step is the processed occupancy and temperature data; the output is a triggered audio alert and creation of an alert data packet containing the time, status, and sensor values.

### Step 3:

The terminal transmits the alert data packet to the server over a wireless communication network. The input of this step is the alert information generated in Step 2. The terminal converts the local data into a structured message and sends it via internet protocol. The output is successful transmission of alert information to the server.

### Step 4:

The server receives and parses the alert information transmitted by the terminal. The server references its registration database to retrieve a list of relevant external information processing terminals. The server generates and sends push notifications to all registered external terminals via a push notification service. The input is the alert data packet; the output is the distribution of notifications to mobile devices associated with guardians or other responsible parties.

### Step 5:

The server generates a dialogue prompt sentence for the person in the vehicle using a generative AI model. The input includes alert context (presence detection, temperature, risk status) and may include user profile data. The server processes this data to craft an appropriate prompt sentence, such as a question or reassuring message. The output is a text or audio prompt, which is delivered to the person in the vehicle through the terminal's speaker or display.

### Step 6:

The user responds to the prompt by speaking or entering a response on a touch display. The input is the received prompt and the user's verbal or manual reply. The terminal captures the audio, performs speech-to-text conversion if necessary, and sends the transcribed response to the server as a data packet. The output is the transmission of the digitized user response to the server.

### Step 7:

The server processes the user's response. The input is the text of the user's reply. The server calls an emotion analysis function to evaluate the emotional tone of the response, such as detecting anxiety, panic, or calmness. The server stores the analysis result in its session log. The output is the calculated emotional state and updated user profile for subsequent processing.

### Step 8:

The server adapts its communication strategy based on the emotion analysis and dialogue history. The input includes the user's latest response, emotional state, and previous dialogue. The server uses the generative AI model to create a new prompt sentence that may contain instructions or reassurance, tailored to the user's current condition. The output is an updated prompt, which is sent back to the terminal for presentation to the user.

### Step 9:

The server compiles the latest status information, including alert status, dialogue history, and emotion analysis results. The server sends real-time status updates as notifications to all registered external terminals to keep guardians and personnel informed. The input is the latest session data and system context; the output is the delivery of summary notifications to external information processing terminals.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

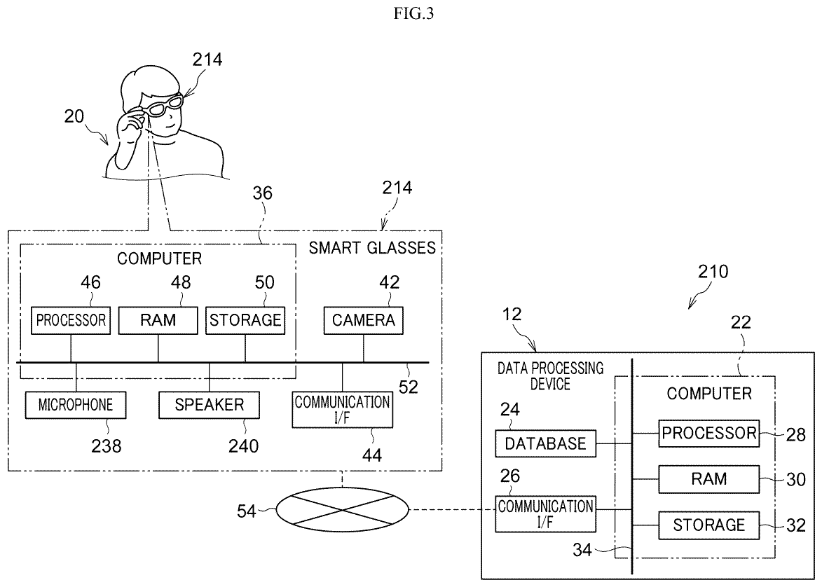

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

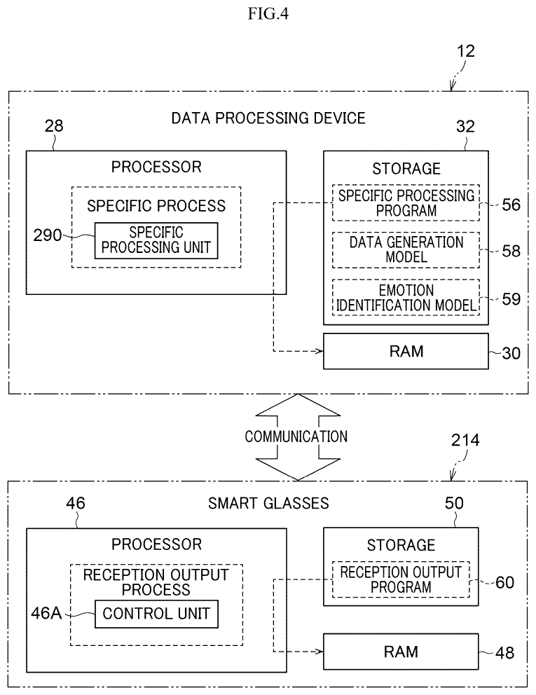

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

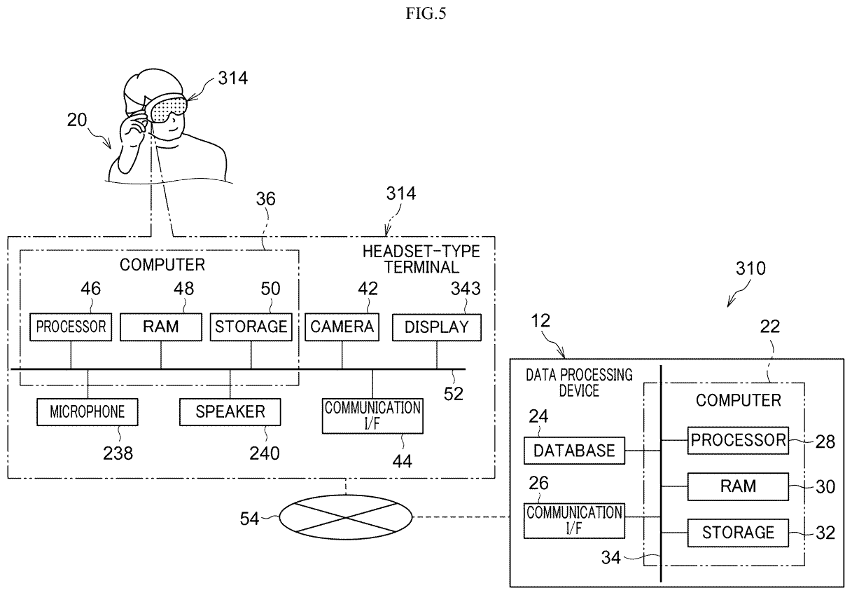

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

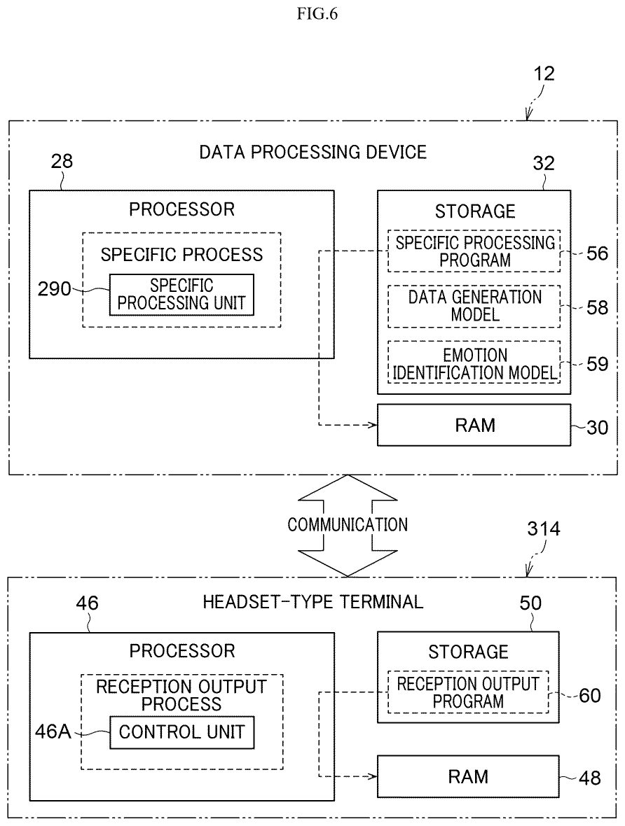

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

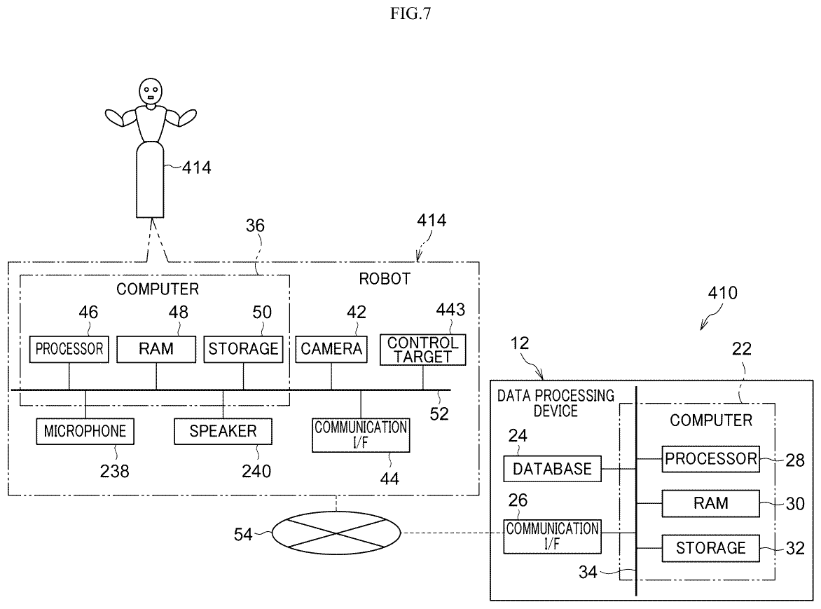

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

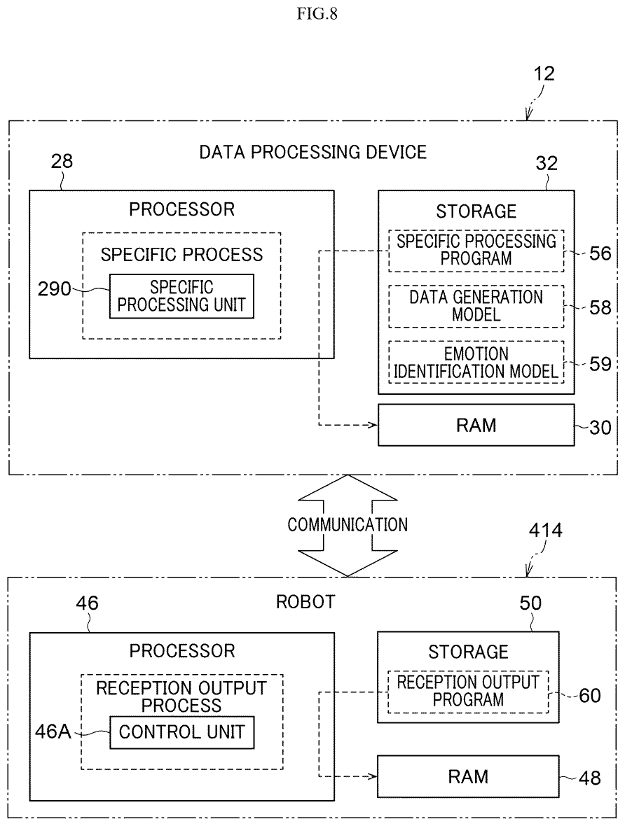

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

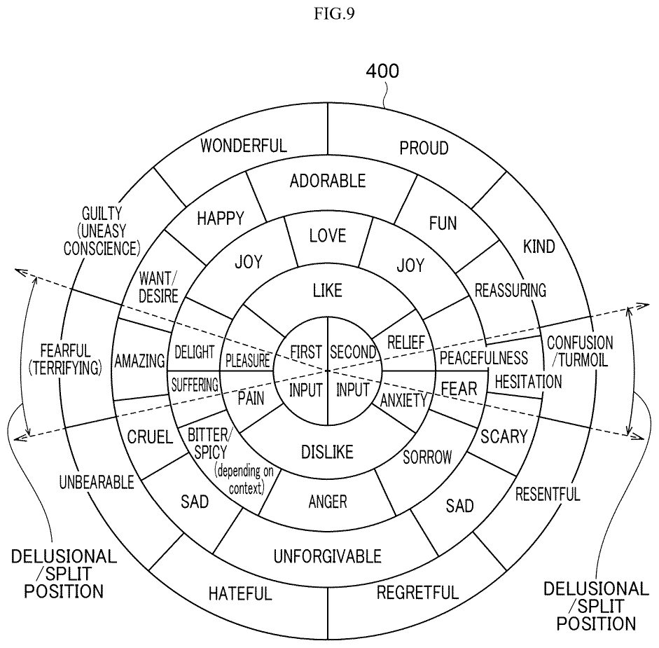

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

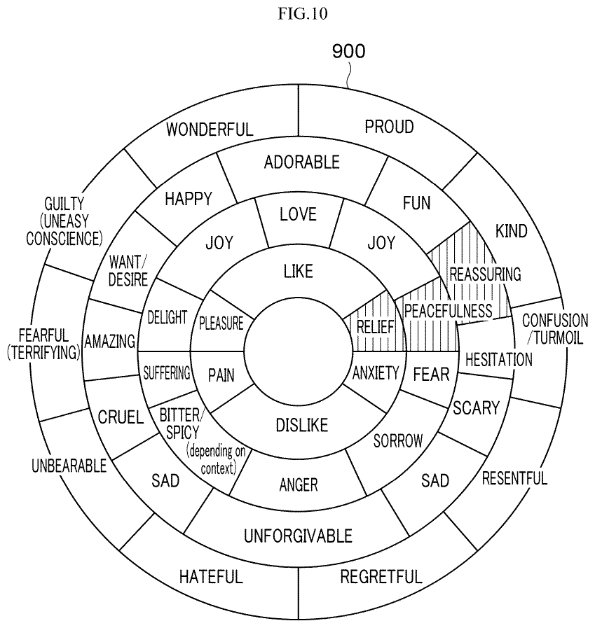

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system including a processor,
wherein the processor is configured to
periodically analyze person detection data obtained from a detection device and determine whether a subject remains inside a vehicle;
monitor operational state signals of the vehicle and, under predetermined conditions including engine shutdown and unlocking, when the subject is determined to remain inside the vehicle, output an audio warning;
transmit, upon issuing the warning, alert data via a communication network to an information processing device;
cause, based on received alert data, notification of alert information to be sent to a registered group of mobile communication terminals;
transmit an instruction sentence including a situational description to a conversation generation processing device, and provide output conversation content from the conversation generation processing device via audio or display through an in-vehicle terminal; and
obtain response data from the subject to the conversation content, and record and transfer the information in real time to external terminals.

### Supplementary 2

The system according to supplementary 1,
wherein the processor is configured to
analyze vehicle interior temperature data obtained from a temperature detection device, determine abnormality when a preset threshold is exceeded,
output an audio warning upon detecting abnormal temperature,
transmit abnormal temperature occurrence information to an information processing device via a communication line, and
notify registered mobile communication terminals based on the received abnormal temperature information.

### Supplementary 3

The system according to supplementary 1,
wherein the processor is configured to
activate a generative information processing model upon receiving alert information, input a predetermined instruction sentence as a prompt to the model to generate, in natural language form, conversation content for confirming the situation of the subject and providing behavioral guidance, and
collect in sequence response results of the subject to the generated conversation content and notify external terminals.

### Application Example 1

### Supplementary 1

A system including a processor,
wherein the processor is configured to
receive information obtained from an imaging apparatus equipped with a sensor,
determine the presence of a subject inside a mobile body based on the received information,
detect an unlocking operation of the mobile body and, if the subject remains inside, output a warning via audio sound,
transmit warning information to an external information processing apparatus,
send notifications based on the transmitted warning information to a plurality of previously registered information terminals,
output the warning content to the information terminals,
receive user responses via the information terminals,
generate guidance text based on the warning information and user responses by using a generative model,
output the generated guidance text according to the user's situation, and
store the guidance text and user responses in a database.

### Supplementary 2

The system according to supplementary 1,
wherein the processor is configured to
record temperature data obtained from a temperature measurement unit provided in the mobile body,
detect abnormal temperature based on the temperature data,
output a warning via audio sound when an abnormal temperature is determined, and
transmit the warning information to an external information processing apparatus and send a notification to a plurality of previously registered information terminals.

### Supplementary 3

The system according to supplementary 1,
wherein the processor is configured to
perform situation confirmation by natural language dialogue processing based on warning information or temperature information,
generate guidance or advice text using a generative model based on situation information collected through dialogue processing and output the guidance or advice to the information terminals, and
transmit the guidance text and situation information to an external information processing apparatus.

### Example 2

### Supplementary 1

A system including a processor,
wherein the processor is configured to
receive information from an imaging device having a human detection function,
determine the presence or absence of a person inside a mobile body based on the received information,
upon detecting both a stop of a power source and removal of an operation medium, and if a person is detected inside the mobile body, output audio alert information,
transmit the alert information to an external information processing device,
send a notification to a plurality of registered information terminal devices based on the transmitted alert information, and
aggregate and record response information and situation information received from each information terminal device.

### Supplementary 2

The system according to supplementary 1,
wherein the processor is configured to
receive environmental data obtained from a portable observation device monitoring the internal environment of the mobile body,
determine whether the environmental status exceeds a set value,
output audio alert information when the abnormal situation is determined,
transmit the alert information to an external information processing device, and
based on the transmitted alert information, send a notification to a plurality of registered information terminal devices and, as needed, record and share changes in situation or response history.

### Supplementary 3

The system according to supplementary 1,
wherein the processor is configured to
receive alert information,
perform situation confirmation and behavioral instruction through natural language dialogue using a generative information processing model,
analyze the content of the dialogue and emotional state of the person, and dynamically optimize the dialogue or response, and
transmit a record containing situation information obtained through the dialogue and used generative dialogue input sentences to an external information processing device and share and notify the plurality of information terminal devices.

### Application Example 2

### Supplementary 1

A system including a processor,
wherein the processor is configured to
receive detection information from an imaging device having a human detection function,
determine the presence or absence of a person in a vehicle compartment based on the detection information,
issue an audible warning when an activation apparatus for the vehicle has been removed and a person is detected in the vehicle compartment,
transmit warning information to an external communication device,
send notifications to a plurality of registered information processing terminals based on the transmitted warning information,
collect response information from within the vehicle compartment through bidirectional communication,
generate guidance content including prompt sentences appropriate to the detected situation using a generative information processing model, and present the guidance content to the person in the vehicle compartment,
analyze response information from the person using an emotion analysis function to generate an appropriate instruction sentence based on the analysis result, and
present the instruction sentence to the person.

### Supplementary 2

The system according to supplementary 1,
wherein the processor is configured to
receive measurement values from a detection device that monitors physical quantities within the vehicle compartment,
determine an abnormal condition when a predetermined threshold has been exceeded,
issue an audible warning in response to the detected abnormal condition,
transmit information regarding the audible warning to an external communication device, and
send notifications to a plurality of registered information processing terminals.

### Supplementary 3

The system according to supplementary 1,
wherein the processor is configured to
receive notification information, dialogue history, and emotion analysis results, and
provide in real time said information to a plurality of registered information processing terminals via the external communication device.

What is claimed is:

1. A system comprising a processor, wherein the processor is configured to
receive data from a camera equipped with a human detection sensor,
detect the presence of a person inside a vehicle based on the data,
emit a voice alert when a vehicle key is removed and a person is detected as remaining inside the vehicle,
transmit alert information to an external communication device, and
send a notification to a plurality of registered terminals based on the transmitted alert information.

2. The system according to claim 1, wherein the processor is configured to
receive temperature data from a portable device that monitors the temperature inside the vehicle,
detect an abnormal temperature based on the received temperature data,
emit a voice alert when an abnormal temperature is detected,
transmit alert information to an external communication device, and
send a notification to a plurality of registered terminals based on the transmitted alert information.

3. The system according to claim 1, wherein the processor is configured to
receive alert information and performs a dialogue using natural language processing technology,
collect situation information through the dialogue and provides instructions for requesting help, and
transmit the situation information to an external communication device.
